(19) United States
(12) Patent Application Publication
(10) Pub. No.: US 2008/0014928 A1
(43) Pub. Date: Jan. 17, 2008

(54) Method of wireless network roaming and mobile phone using the same

(75) Inventor: Chih-Wen Chen, Hsinchu County (TW)

Correspondence Address: QUINTERO LAW OFFICE, PC, 2210 MAIN STREET, SUITE 200, SANTA MONICA, CA, 90405, US

(73) Assignee: WISTRON NEWEB CORP., TAIPEI HSIEN (TW)

(21) Appl. No.: 11/644,797

(22) Filed: Dec. 22, 2006

(30) Foreign Application Priority Data
Jul. 11, 2006 (TW) TW95125231

(51) Int. Cl. H04Q 7/20

(52) U.S. Cl. 455/432.1

(57) ABSTRACT

A mobile phone is provided. The mobile phone comprises a communication unit, a signal detection unit, and a processor. The communication unit establishes a first communication connection between a first wireless access point and the mobile phone. The signal detection unit detects a current signal strength value of the first communication connection. The processor compares the current signal strength value with a preset first critical value, when the current signal strength value is lower than the first critical value, performs a scanning procedure for wireless access points to establish a list comprising identification information of at least one wireless access point, selects a wireless access point from the list as a second wireless access point, and causes the communication unit to establish a second communication connection between the second wireless access point and the mobile phone.

### BACKGROUND

The invention relates to mobile phones, and in particular to a wireless network roaming mechanism for a mobile phone.

This section is intended to introduce the reader to various aspects of the art, which may be related to various aspects of the invention, which are described and/or claimed below. This discussion is believed to be helpful in providing the reader with background information to facilitate a better understanding of the various aspects of the invention. Accordingly, it should be understood that these statements are to be read in this light, and not as admissions of related art.

Roaming is an important function for mobile phones in any type of telecommunication system. If a mobile phone is not provided with a roaming function, a call may be interrupted when the mobile phone travels from a base station to another base station. If the roaming function of a mobile phone is poor, poor communication quality during roaming may result. Examples of poor communication include, for example, discontinuity in the transmitted voice signal, or possibly several seconds of silence during a call session.

The communication range covered by an access point of a wireless network is smaller than a base station of a GSM network. Thus, in a wireless network, several access points are required in a small area. Accordingly, the roaming function of a mobile phone is more important when used in a wireless network.

A wireless network roaming mechanism providing unhindered roaming for a mobile phone communicating in a wireless network is thus desirable.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention.

A method of wireless network roaming for a mobile phone is provided. A first communication connection is established between a first wireless access point and a mobile phone. A current signal strength value of the first communication connection is detected. The current signal strength value is compared with a first critical value. When the current signal strength value is lower than the first critical value, a scanning procedure for locating wireless access points is performed to establish a list comprising identification information of at least one wireless access point. A wireless access point is selected from the list as a second wireless access point. A second communication connection is established between the second wireless access point and the mobile phone.

Also provided is a mobile phone. The mobile phone comprises a communication unit, a signal detection unit, and a processor. The communication unit establishes a first communication connection between a first wireless access point and the mobile phone. The signal detection unit detects a current signal strength value of the first communication connection. The processor compares the current signal strength value with a preset first critical value, when the current signal strength value is lower than the first critical value. A scanning procedure for locating wireless access points is performed to establish a list comprising identification information of at least one wireless access point. A wireless access point is selected from the list as a second wireless access point causing the communication unit to establish a second communication connection between the second wireless access point and the mobile phone.

### BRIEF DESCRIPTION OF DRAWINGS

The invention can be more fully understood by reading the subsequent detailed description and examples with references made to the accompanying drawings, wherein:

FIG. 1 is a schematic view of an embodiment of a wireless communication network;

FIG. 2 is a schematic view of an embodiment of a mobile phone;

FIGS. 3A˜3E are a flowchart of an embodiment of a method of wireless network roaming for a mobile phone; and

FIG. 4 is a flowchart of an embodiment of a scanning procedure for wireless access points.

### DETAILED DESCRIPTION

One or more specific embodiments of the invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve developer specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

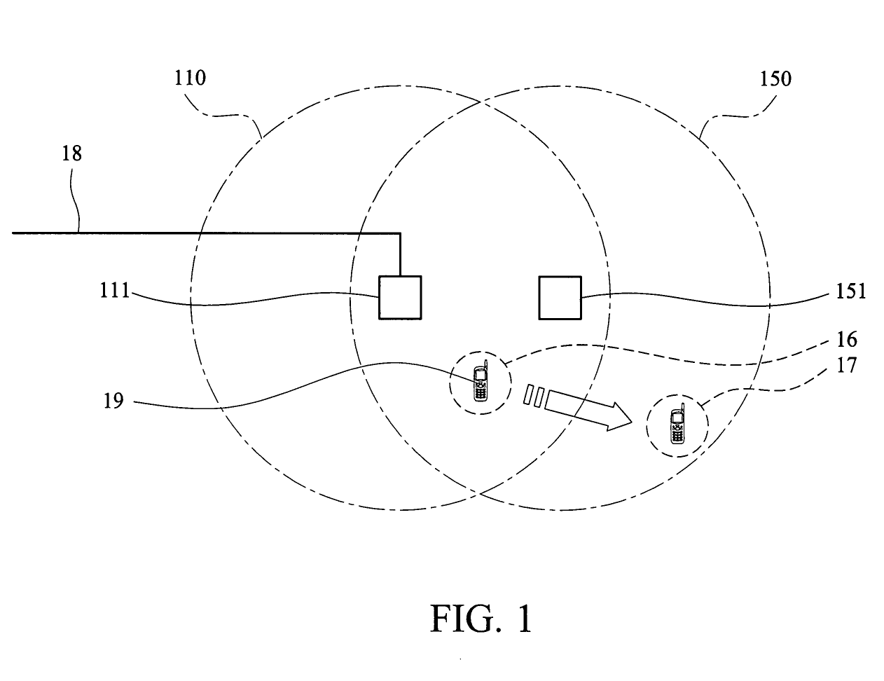

The invention is now described with reference to FIGS. 1 through 4, which generally relate to controlling a mobile phone. In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures correspond to the Figure number, with the exception that the same reference number is used throughout to refer to an identical component which appears in multiple figures. It should be understood that many of the elements described and illustrated throughout the specification are functional in nature and may be embodied in one or more physical entities or may take other forms beyond those described or depicted.

FIG. 1 is a schematic view of an embodiment of a wireless communication network. FIG. 1 illustrates wireless local area networks (WLANs) 110 and 150. Devices capable of wireless communication can access WLANs 110 and 150 through access points 111 and 151, respectively.

WLAN 110 comprises two basic elements: access point 111 and client network card (not shown). Access point 111 connects to wired network backbone 18. Similarly, WLAN 150 comprises access point 151 and client network card (not shown). The access point is the central point of a WLAN, or a connection point between a wired and wireless network. Multiple access points may be arranged within a building or an important access site, enabling clients equipped with a WLAN network card to maintain uninterrupted connection even when moving. For example, in this case, a mobile phone 19 comprising a wireless communication function can move from location 16 to location 17 using the wireless communication roaming function.

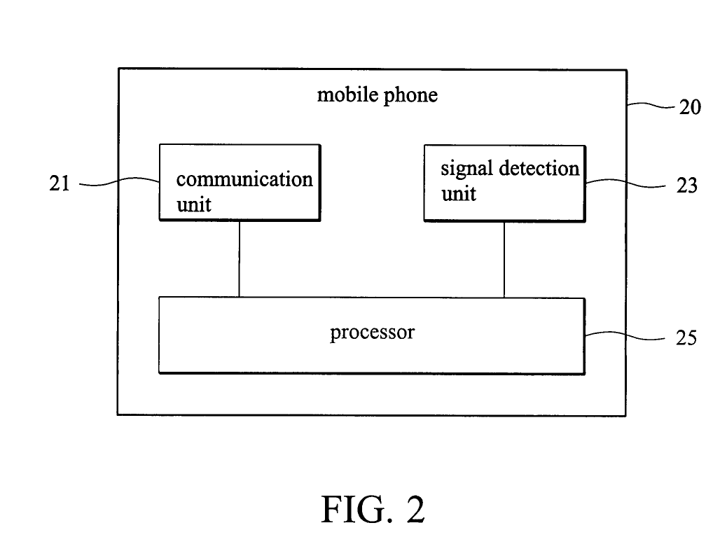

FIG. 2 is a schematic view of an embodiment of a mobile phone. A mobile phone 20 comprises a communication unit 21, a signal detection unit 23, and a processor 25. The communication unit 21 establishes a first communication connection between a first wireless access point and the mobile phone. The signal detection unit 23 detects a current signal strength value of the first communication connection. The processor 25 compares the current signal strength value with a preset first critical value. When the current signal strength value is lower than the first critical value, the processor 25 performs a scanning procedure for wireless access points to establish a list specifying identification of at least one wireless access point, selects a wireless access point from the list as a second wireless access point, and causes the communication unit to establish a second communication connection between the second wireless access point and the mobile phone.

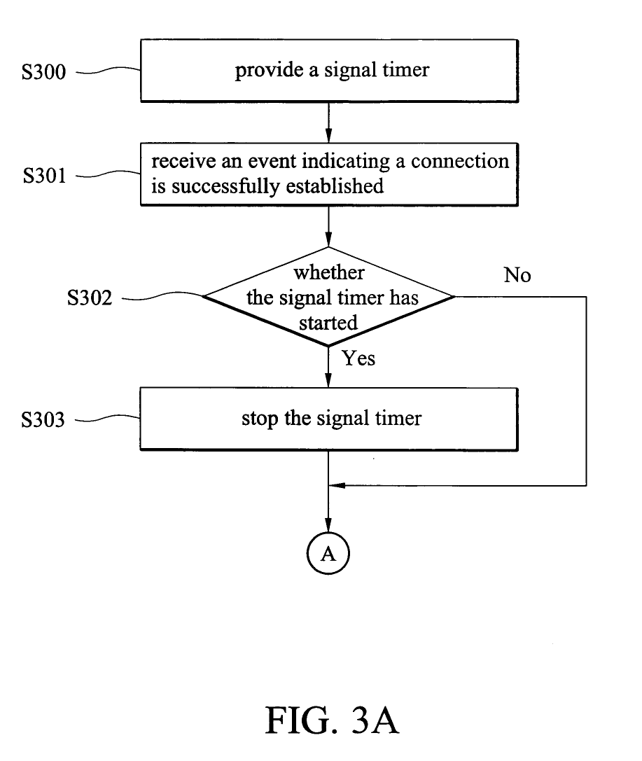

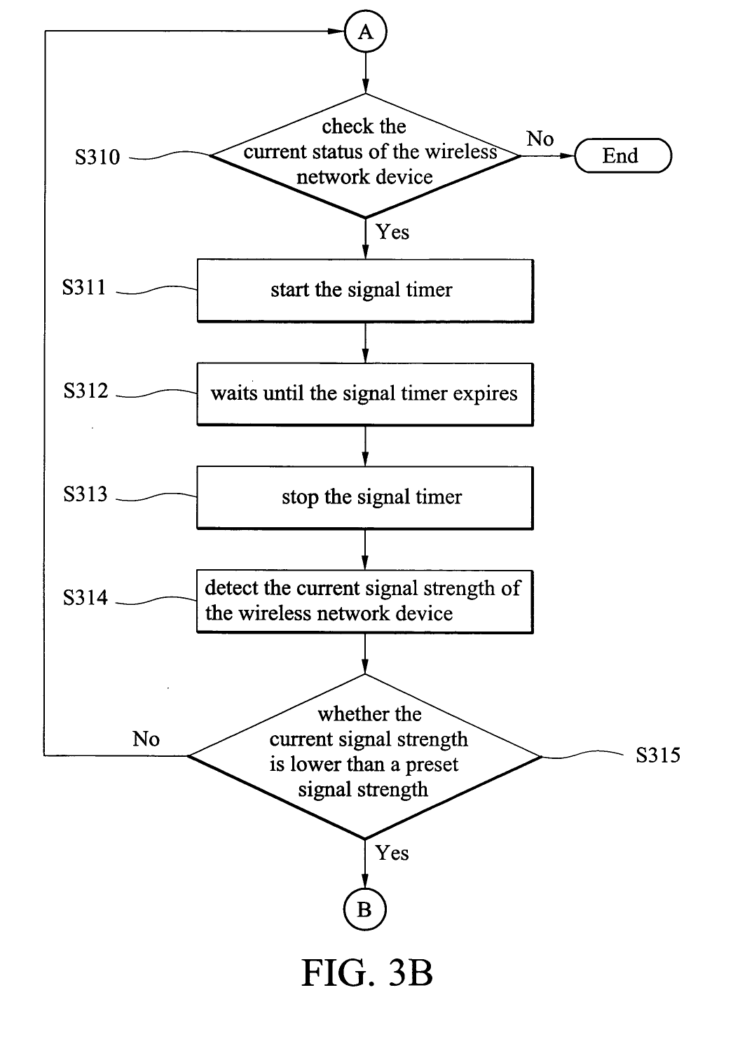

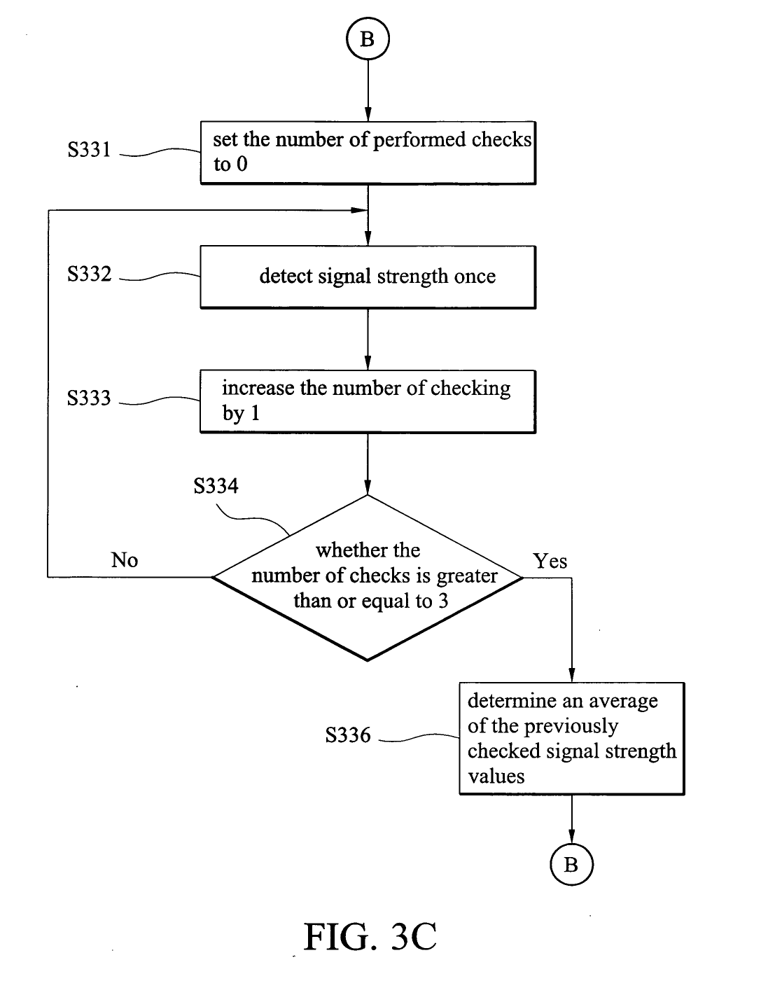

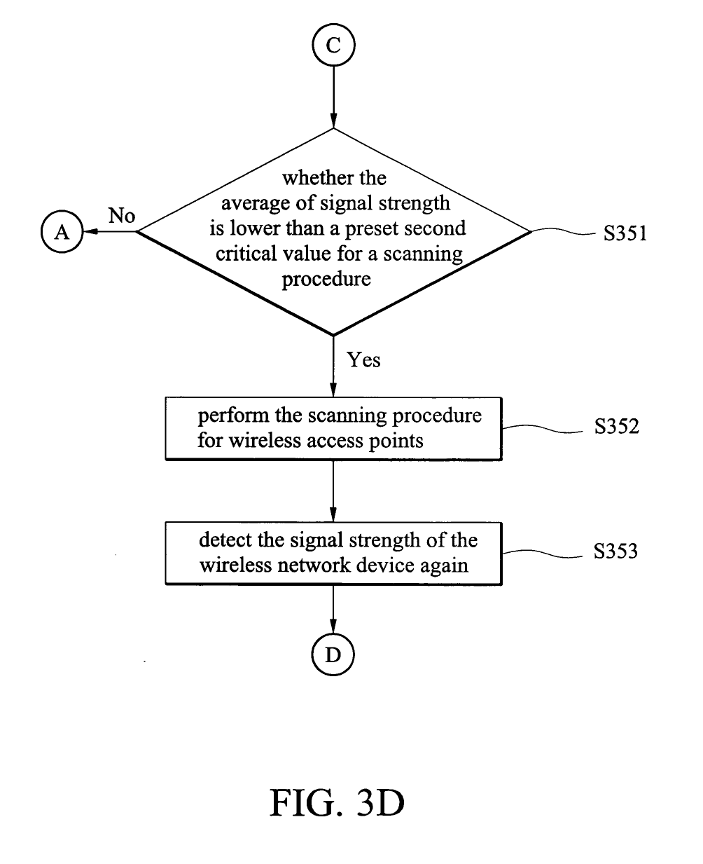

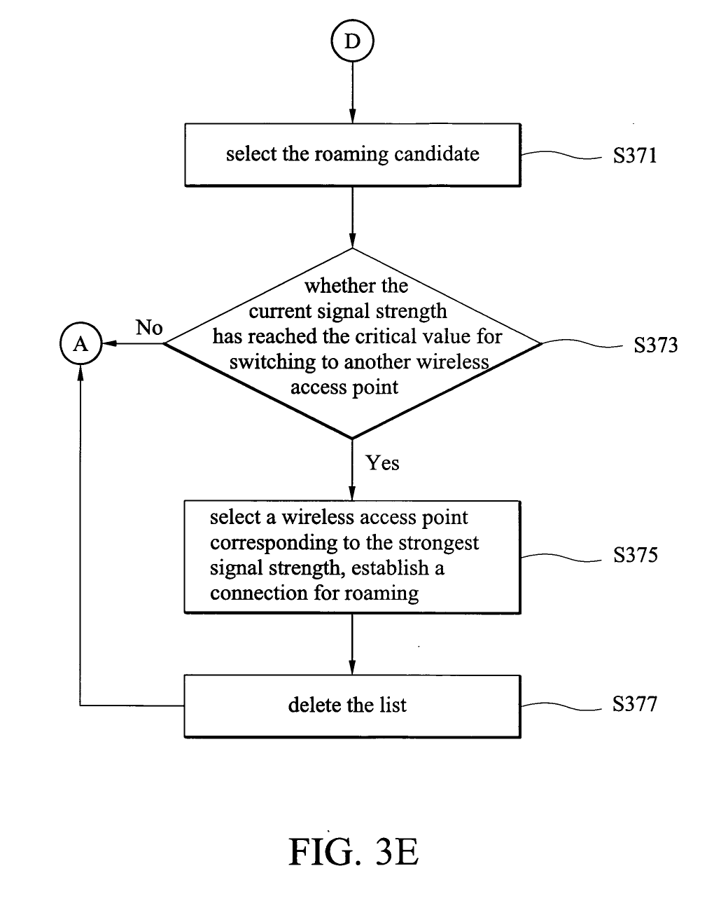

FIGS. 3A-3E are a flowchart of an embodiment of a method of wireless network roaming for a mobile phone.

Referring to FIG. 3A, a signal timer is first provided (step S300). The signal timer triggers signal strength detection when a preset timer has expired. In step S301, an event occurs, indicating a connection is successfully established. It is determined whether the signal timer has started (step S302), and if so, the signal timer is stopped (step S303), otherwise, the method proceeds to procedure A.

Referring to FIG. 3B, step S310 is executed in response to entering procedure A, checking the current status of the wireless network device. Here, a bConnect parameter is used to specify the current status of the wireless network device. Updating of the bConnect parameter depends on current connection status of the wireless network device, the bConnect parameter is true if the connection status is “connected”, and false if the connection status is “disconnected”. If the connection status of the wireless network device is “connected”, a roaming operation may be required. The signal timer is started (step S311), and waits until the signal timer expires (step S312). When the signal timer expires, the signal timer is stopped (step S313), and the current signal strength of the wireless network device is detected (step S314). In step S315, it is determined whether the current signal strength detected in step S314 is lower than a preset signal strength (i.e., a first critical value for performing a scanning procedure). When the current signal strength value is lower than the first critical value, the method proceeds to procedure B to determine whether to perform the scanning procedure for wireless access points.

Referring to procedure B of FIG. 3C, before the scanning procedure is performed, the signal strength is detected several times, and an average of the detected results is calculated. It can thus validate whether the inadequate signal strength assessed in step S315 is a result of a transient interference. In step S331, the number of performed checks is set to 0. In step S332, signal strength is detected once. In step S333, the number of checking is increased by 1. In step S334, it is determined whether the number of checks is greater than or equal to 3, and if so, the method proceeds to step S336, otherwise, the method returns to step S332 to again check the signal strength. In step S336, an average of the previously checked signal strength values is determined, and the method proceeds to procedure C.

Referring to procedure C of FIG. 3D, the scanning procedure for wireless access points is performed. In step S351, it is determined whether the average of signal strength is lower than a preset second critical value for a scanning procedure, and if so, the method proceeds to step S352, otherwise, the method returns to procedure A. Here, the critical value for a scanning procedure can be specified in dbm units. For example, when the critical value is −75 dbm, if the signal strength is lower than −75 dbm, the scanning procedure is performed to scan wireless access nearby points.

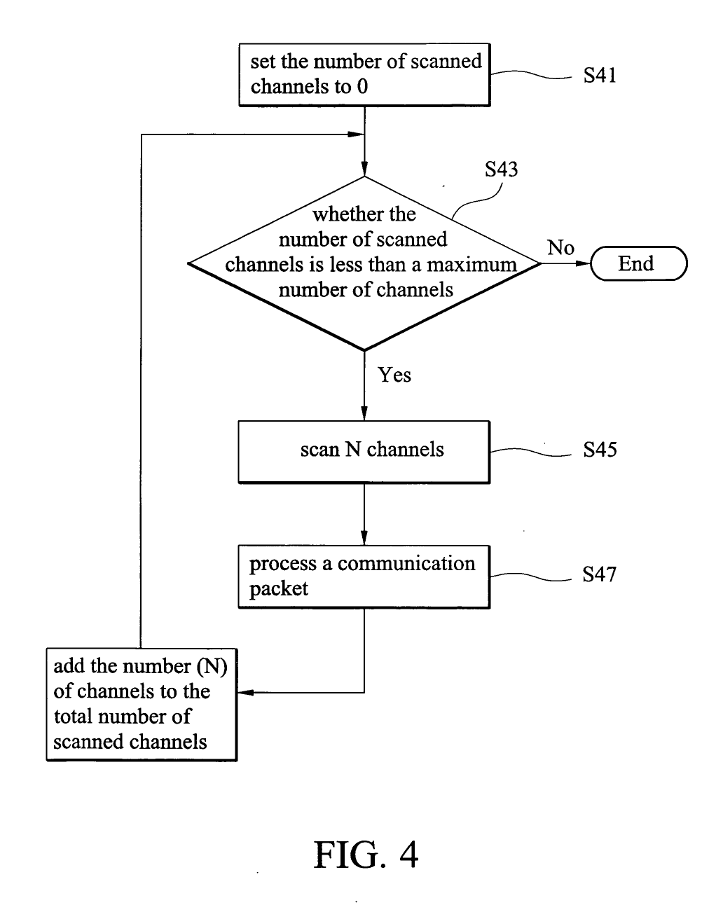

In step S352, the scanning procedure for wireless access points is performed. The scanning procedure performed in step S352 is implemented in sections, as detailed in FIG. 4.

Step S353 is performed subsequent to the scanning procedure. In step S353, the signal strength of the wireless network device is again detected. The scanning procedure may take 10 to 100 milliseconds. During this period, signal strength may have changed due to movement of the wireless network device. Step S353 is thus required to again check the signal strength. After the checking again, the method proceeds to procedure D.

In procedure D of FIG. 3E, a list of roaming candidates is determined. In step S371, the roaming candidate is selected according to the result of the scanning procedure. If the signal strength of a wireless access point is higher than or equal to the current signal strength plus a preset difference, the corresponding wireless access point is then designated as a roaming candidate. The preset difference can be specified in dbm units. For example, when the preset difference is 20 dbm, if signal strength of a wireless access point exceeds the current signal strength by 20 dbm, the corresponding wireless access point is then specified in the list of roaming candidates.

In step S373, it is determined whether the current signal strength has reached the critical value for switching to another wireless access point. If so, the method proceeds to step S375 to initiate a roaming procedure, otherwise, the method returns to procedure A. The critical value for switching to another wireless access point can be specified in dbm units. For example, when the critical value is −85 dbm, if the current signal strength is lower than −85 dbm, a wireless access point switching procedure is initiated.

In step S375, a wireless access point corresponding to the strongest signal strength is selected form the list of roaming candidates, and a connection is established between the selected wireless access points for roaming.

In step S377, the list generated in step S371 is deleted, and the method returns to procedure A.

FIG. 4 is a flowchart of an embodiment of a scanning procedure for wireless access points. In step S41 the number of scanned channels is set to 0. In step S43, it is determined whether the number of scanned channels is less than a maximum number of channels, and if so, the method proceeds to step S45, otherwise, all channels have been scanned, and the method ends. In step S45, N channels are scanned. In step S47, a communication packet is processed. The time consumed by processing the communication packet is essentially equal to the time consumed by scanning the N channels. In step S49, the number (N) of channels scanned in step S45 is added to the total number of scanned channels.

According to this embodiment, two advantages can be achieved. First, a roaming mechanism is provided. Here, a mobile phone capable of wireless network communication links to a wireless access point, and moves between wireless access points specified by the same SSID. It is determined, according to the described roaming mechanism, whether switching to another wireless access point is required based on the current connection status of the mobile phone. Second, an improved roaming service is provided. To enable the roaming function, the current connection status of the mobile phone must be checked intermittently. In addition, it is determined whether to switch to another wireless access point in response to poor connection status. Searching for nearby wireless access points corresponding to the same SSID, and selecting one of the wireless access points as a target for switching to is also required. The efficiency of roaming depends largely on the procedure of scanning for nearby wireless access points corresponding to the same SSID. This invention comprises some scanning procedure features. (1) The scanning procedures can be distinguished as active scan and passive scan. This invention utilizes the active scan. (2) The target of the scanning procedure is limited to the wireless access point corresponding to the same SSID. (3) The mobile phone may be in the middle of a call session (VOIP) when roaming, i.e., the mobile phone transmits and receives packets when roaming. In this case, packets may be lost and/or delayed, and the voice transmission of the call session may be discontinuous and/or interrupted. The scanning procedure is, therefore, performed in sections. According to the sectional scanning procedure, sections of channel scanning and packet processing alternate until all of the channels are scanned. The time consumed by alternating sections of channel scanning and packet processing is essentially the same. For example, the time required for one section of channel scanning is equal to the time required for processing one packet, wherein the number of channels scanned during the section of channel scanning varies. For example, it takes 20 ms to transmit one wireless packet, and 10 ms to scan for a wireless channel. In this case, 2 channels are scanned during one channel scanning section. If there are 10 channels to be scanned, then the entire scanning procedure is divided into 5 sections, and 2 channels are scanned during one scanning section, and one packet is transmitted in response to each scanning section.

In addition, the disclosed roaming mechanism provides a signal trigger mechanism. In other words; the signal strength and difference thereof are used to determine whether to perform the roaming procedure, and which wireless access point is assigned as a roaming target. Signals transmitted through wireless networks are sensitive to interference, thus a weakened signal may be due to transient interference. A rechecking mechanism, therefore, is provided to avoid this problem.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of wireless network roaming for a mobile phone, comprising:
establishing a first communication connection between a first wireless access point and a mobile phone;
detecting a current signal strength value of the first communication connection;
comparing the current signal strength value with a first critical value;
when the current signal strength value is lower than the first critical value, performing a scanning procedure for locating wireless access points to establish a list comprising identification information of at least one wireless access point;
selecting a wireless access point from the list as a second wireless access point; and
establishing a second communication connection between the second wireless access point and the mobile phone.

2. The method of claim 1, wherein the scanning procedure further comprises:
scanning N channels; and
processing a communication packet, wherein the time consumed by processing the communication packet essentially equals to the time consumed by scanning the N channels.

3. The method of claim 1, wherein the current signal strength value compared with the first critical value is an average of a plurality of successively detected signal strength values.

4. The method of claim 1, further detecting the current signal strength value after the scanning procedure for locating wireless access points.

5. The method of claim 1, wherein the list comprises the wireless access points, located by the scanning procedure, corresponding to a signal strength value higher than the current signal strength value.

6. The method of claim 1, further selecting the wireless access point corresponding to the highest signal strength value within the list, and assigning the selected wireless access point as the second wireless access point.

7. The method of claim 6, further determining whether the signal strength value corresponding to the selected wireless access point is higher than a second critical value, and if so, assigning the selected wireless access point as the second wireless access point.

8. The method of claim 6, further terminating the first communication connection.

9. A mobile phone, comprising:
a communication unit, establishing a first communication connection between a first wireless access point and the mobile phone;
a signal detection unit, detecting a current signal strength value of the first communication connection; and
a processor, comparing the current signal strength value with a preset first critical value, when the current signal strength value is lower than the first critical value, performing a scanning procedure for wireless access points to establish a list comprising identification information of at least one wireless access point, selecting a wireless access point from the list as a second wireless access point, and causing the communication unit to establish a second communication connection between the second wireless access point and the mobile phone.

10. The mobile phone of claim 9, wherein the processor further scans N channels, and processes a communication packet, wherein the time consumed by processing the communication packet is essentially equals to the time consumed by scanning the N channels.

11. The mobile phone of claim 9, wherein the processor detects a plurality of signal strength values successively, and determines an average of the plurality of signal strength values, using the average as the current signal strength value compared with the first critical value.

12. The mobile phone of claim 9, wherein the processor further detects the current signal strength value after the scanning procedure for wireless access points.

13. The mobile phone of claim 9, wherein the processor further selects the wireless access point from those located by the scanning procedure, wherein the selected wireless access point corresponds to a signal strength value higher than the current signal strength value, and generates the list accordingly.

14. The mobile phone of claim 9, wherein the processor further selects the wireless access point corresponding to the highest signal strength value within the list, and assigns the selected wireless access point as the second wireless access point.

15. The mobile phone of claim 14, wherein the processor further determines whether the signal strength value corresponding to the selected wireless access point is higher than a second critical value, and if so, assigns the selected wireless access point as the second wireless access point.

16. The mobile phone of claim 9, wherein the processor further terminates the first communication connection.
